(19) United States
(12) Patent Application Publication
(10) Pub. No.: US 2005/0022113 A1
(43) Pub. Date: Jan. 27, 2005

(54) System and method to efficiently switch between paper, electronic and audio versions of documents

(76) Inventor: Robert Eliot Hanlon, New York, NY (US)

Correspondence Address: Robert Eliot Hanlon, 755 West End Avenue, New York, NY, 10025, US

(21) Appl. No.: 10/884,041

(22) Filed: Jul. 2, 2004

Related U.S. Application Data
(60) Provisional application No. 60/489,684, filed on Jul. 24, 2003.

(51) Int. Cl. G06F 17/00

(52) U.S. Cl. 715/511

(57) ABSTRACT

A system and method for automatically and conveniently switching among paper, electronic and/or audio forms of a document or other data file by utilizing specialized versions and devices. Each version of the document has a plurality of identifying indicators representing specific locations. The accessing device automatically identifies the indicator associated with the last location accessed and transmits that indicator to other devices by a communication means. Those other devices then access the location in the alternative version corresponding to the location last accessed in the first version. The invention also allows for coordinated access to a document by multiple users on a number or variety of devices.

### CROSS-REFERENCE TO RELATED APPLICATION

This nonprovisional utility patent application claims the benefit of provisional application U.S. Ser. Appl. No. 60/489,684 filed Jul. 24, 2003 and entitled “System and Method to Efficiently Switch Between Paper, Electronic and Audio Versions of Documents,” under 35 U.S.C. § 119. The provisional application is incorporated herein by reference in its entirety.

### FIELD OF INVENTION

This invention relates generally to digital information transmission and playback systems. Specifically, the present invention pertains to methods, systems and apparatuses for synchronizing the access to multiple versions of materials, such as documents, including documents containing textual, graphics, video and/or audio information on various devices in both paper and digital formats.

### BACKGROUND OF THE INVENTION

The advent of digital processing of information has given individuals wishing to access that information a wide range of choices, far beyond that which was available when all data was either in print or on analog recording material, such as vinyl audio records or analog magnetic tape. In particular, digital audio and electronic books have given readers alternatives to conventional paper based books. However, paper, audio and electronic versions of books each have their advantages in different settings. Many people prefer traditional paper books for reading a home or in other relaxed settings. Audio books have advantages when traveling, such as in automobiles or when exercising. Electronic books (e-books) have an advantage of being always available on a handheld device, a laptop or even a desktop computer, and able to be read in the dark or unobtrusively. To date, readers have had to choose among these various media for their books because switching among these formats was cumbersome. Accordingly, it is highly desirable to simplify the process of reading a book or other document in one of these media, and then automatically switching to another of these media in exactly the same place that one left off in the prior medium. Similar benefits can be derived when viewing or listening to other information that is available in both visual and auditory form, such as audio broadcasts and the transcripts of those broadcast, in foreign language study or when the material is available in various visual forms, both electronic and “hard copy,” such as a hard copy of a graphic image and a differing electronic version of that image. Finally, the system of the present invention can be used to coordinate among various persons reading or viewing a document in common, such as in a lecture or presentation.

While some existing e-book reader programs, such as Palm Reader from Palm Digital Media, Inc., provide different versions of the program to enable reading on different platforms, such as a PDA running a Palm Operating System and a desktop computer running a Windows Operating System, none of these programs provide for the coordination of the reviewing process to allow seamless transition from one platform or one machine to another.

Various other inventions address related issues, but do not teach the processes required to achieve the benefits of the present invention. For example, U.S. Pat. No. 4,855,752 to Fernandez describes an electronic book which is stored on a CD ROM, transferred to a computer and in turn transferred to a device for displaying a simulated book. This device and system do not provide methods for accessing the electronic document on more than one device and provide no means of synchronizing progress through multiple versions of the documents.

U.S. Pat. No. 5,710,922 to Alley, et al., describes a method for adding or deleting data on one computer system and then adding or deleting data on a separate computer system so that the data on the second system changes to correspond to the data on the first system. This method intrinsically alters the basic data, rather than providing a system of preserving the data in various forms, including non-identical forms, and does not provide means to coordinate the access to certain sections of that data on various devices or platforms.

Cassorla, et al. describe, in U.S. Pat. No. 5,146,552, a method to allow a reader of an electronic book to create annotations within a single book or to exchange them with an identical copy of that book. This method requires active intervention on the part of the reader and does not coordinate place markers among various copies or forms of books, nor does it provide for alternative opportunities to view materials on different types of devices that have differing display or presentation capabilities.

The method of U.S. Pat. No. 5,957,697 to Iggulden, et al. describes a printed book with associated data that is intrinsically different from that in the printed book. The methods in that patent also provide placement indicators, but there is no method or mechanism to automatically coordinate the access to the corresponding location on multiple versions of the document.

U.S. Pat. No. 5,991,594 to Froeber, et al., describes devices capable of storing a single version of a document in the form of electronic text and a means of playing that text through a portable speech synthesizer while the text is displayed on a screen. These inventions do not allow coordination among a plurality of versions of an electronic document, and make no provision for synchronization among various types of devices.

Devices are described in U.S. Pat. No. 5,914,706 to Kono and Mitsuru that are capable of simultaneously displaying or processing textual and audio data on the same device based on user input. However, these devices are not capable of providing sequential coordinated access on multiple devices or other documents formats.

### SUMMARY OF INVENTION

The present invention provides a system and method for automatically and easily switching among paper, electronic and/or audio forms of a document or other data file (collectively “documents”).

One embodiment of the present invention begins with at least two, but possibly multiple versions of a book or other material, including one or more of the following: paper, electronic (text only), electronic (text and graphics), electronic (graphics only), electronic (video) and audio versions or combinations thereof. Typically, each version has a plurality of common or analogous identifying indicators to represent the locations or “pages” within each version (“location indicators”). Desirably, each version has an “index” correlating location indicators with at least one other version. In a preferred embodiment of the present invention, a location indicator corresponding to the portion of the document presently being, or last viewed by the reader, viewer or listener (“user”) is recorded or noted for at least one version of a document. It is further desired that the location indicator is rerecorded or noted each time the user moves to another portion of the document corresponding to another location indicator. In a particularly desired embodiment of the present invention, when the user changes to another version of the document on a different device (which may consist of an electronic device or a paper version, which is its own device), the system transmits or provides a basis for determining the most recent location indicator stored for the first version of the document to an alternative device which contains a corresponding version of the document. It is still further desired that the system of the present invention advances the alternative version on the alternative device to the portion of the alternative version corresponding the last location indicator recorded for the first version.

The invention allows for both continuous and on-demand communication systems among viewing and listening devices, and may utilize a range of communications methodologies to maintain coordination among the various media, including wireless broadcast, optical scanning, voice recognition and manual code entry, as well as through wired communication.

An alternative embodiment of the present invention coordinates between two or more persons who are accessing multiple copies of a document simultaneously. This embodiment enables one of the users to advance the progress through the text or graphics so that all of the individuals participating are viewing the same or corresponding “page,” i.e., location within the document, at the same time.

### BRIEF DESCRIPTION OF THE DRAWINGS

For a further understanding of the nature and objects of the present invention, reference should be made to the following detailed non-limiting description, taken in conjunction with the accompanying drawings, wherein:

FIG. 1 is a display diagram showing a plurality of versions of a document having document identifiers and a plurality of location indicators.

FIG. 2 is a display diagram showing a plurality of versions of a document on alternative types of media having document identifiers and a plurality of location indicators.

FIG. 3 is a high-level block diagram showing a process of advancing though a document on one device and transmitting information to an alternative device to allow synchronized access.

FIG. 4 is a high-level block diagram showing a process of advancing though a document on one device and transmitting information to an alternative device to allow synchronized access based on data type.

### DETAILED DISCLOSURE OF THE EMBODIMENTS

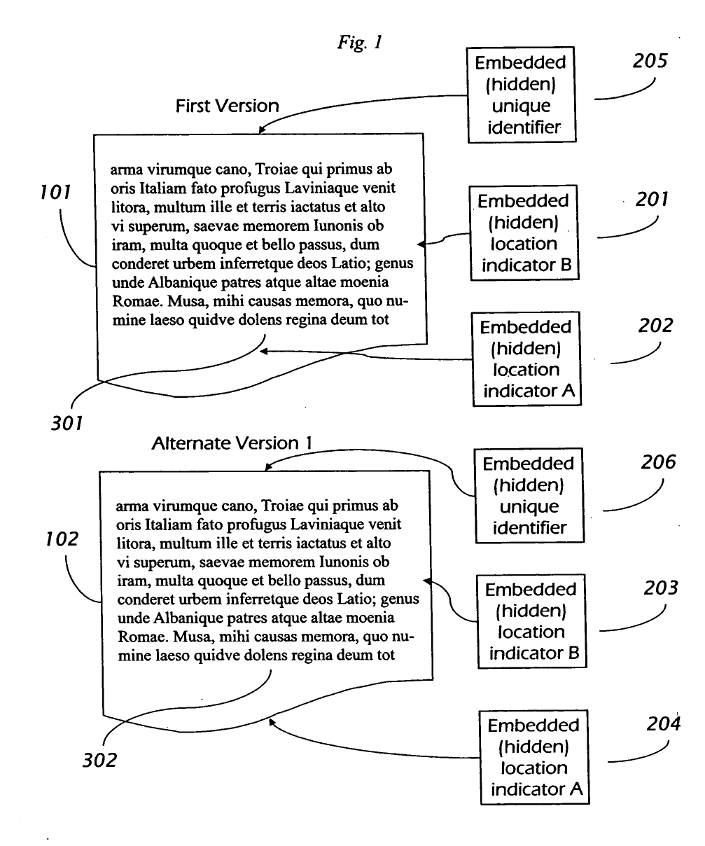

As illustrated in FIG. 1, a first version of a document 101 is generated which has location indicators 201 and 202 within the document that reflect progressive locations within the document (“location indicators”). These location indicators 202 can correspond to traditional pages of a paper, bound, traditional book or may reflect smaller units within each conventional page, such as a point within a single screen of a handheld device. In an alternative embodiment, the location indicators 201 could correspond to paragraph numbers, inches of magnetic tape processed or tracks or portions thereof on audio media.

One or more alternative versions of the document 102 are generated, each of which have the same or analogous location indicators 203 and 204 in the corresponding locations within each alternative version of the document as those in the first version. The location indicators are discrete from the content data 301 and 302 contained in the document and are capable of being recognized and stored by the viewing or playing device, or on removable media accessible to such device, as the user accesses any given location within the content data, as well as being recognized and updated as the user progresses through the content data. These location indicators are also capable of being processed separately from the content data by the devices that are equipped to view or play the various versions of the document.

These alternative versions may include a pre-printed paper version of the document that can be read directly. The location indicators in a paper version could be recorded, within a given page of the document, as one or more a numerical indicators, bar codes or other discrete markings using optical, magnetic, ultraviolet or other media that can be perceived by the human senses or by a mechanical, electronic, optical or other type of receptor. Alternative versions may also include an electronic text or graphic version of the same document, such as might be viewed on a device such as a personal digital assistant or on a personal or networked computer. Such versions may also include an audio or video version as might be recorded on audio tapes, CDs, DVDs, mini-disks, hard drives, flash memory or any other medium for storing audio or video files and capable of being digitally processed or accessed, regardless of the type of device on which those audio or video files are intended to be played. Such versions may also include an electronic text file that is capable of be transformed electronically into an audio file.

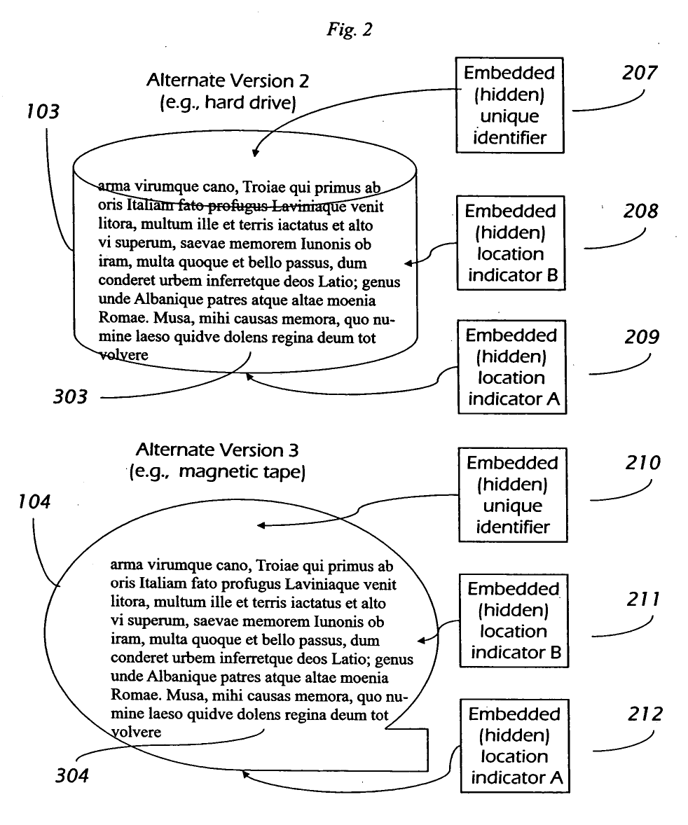

As illustrated in FIG. 2, the documents, other than paper versions, are stored on either fixed or removable digital data storage mechanisms, including but not limited to hard drives 103, flash memory, CDs, DVDs, minidisks, DATs 104, ROM, PROM, EPROM, RAM, DRAM, SRAM or any other permanent or programmable storage medium currently known or formats which may become available in the future.

In one embodiment of the invention, two or more of the various versions of the document capable of electronic, digital or optical storage and playback are combined in one file with separate components capable of being viewed on various types of devices, either within a document reader or player, or in a separate viewer or player that can be activated from within the primary viewer or player at the appropriate time.

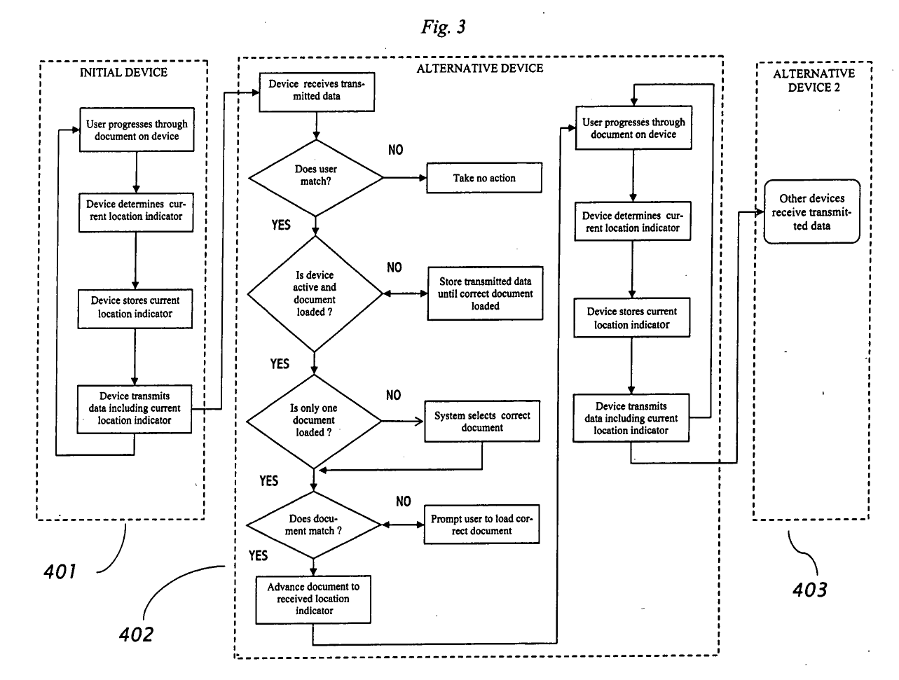

As illustrated in FIG. 3, in some embodiments of the invention, in which one user is utilizing the invention to view or play a document on two or more types of devices 401, 402 and 403 sequentially, one device 401 (the “initial device”) capable of viewing a textual or graphic electronic version of the document is equipped with a transducer capable of sending and receiving data (“transmitted data”), including the location indicators, utilizing electromagnetic frequency signals. Such transducers may utilize standardized or proprietary formats or protocols, such as WiFi, Bluetooth or IrDA, for communicating with comparable or analogous transducers on other devices that are capable of viewing or playing the document. As the user progresses through the document on the initial device, the device uses a processor that determines the location indicator associated with a predetermined location on the page or screen being displayed or the last location indicator passed in the text, graphics, video or audio stream being reviewed or played, stores that information concerning the location indicator in a temporary or long term memory, and transmits a signal that communicates that location indicator to any other viewing or playing device 402 within range. The processor can consist of software, firmware, hardware or a combination of such devices and mechanisms. If the alternative viewing or playing device 402 (“alternative device”) that receives the transmitted data is active, that alternative device will determine whether there is a corresponding document currently present and ready for viewing (“loaded”). If there is no document loaded, the device will store the transmitted data and prompt the user to insert a document. If there are more than one documents loaded, the device will either review its memory to determine which is the document last viewed or listened to by the user, designate that document as the preferred document and load that document for listening or viewing; or, in the alternative, the device will inquire of the user, through a visual or auditory interface, which document the user wishes to select. If only one document is loaded, the device will assume that the loaded document is the preferred document and will identify and select that document and determine whether it corresponds to the document for which data has been received.

Once a corresponding document is both loaded and selected, the alternative device 402 will review the transmitted data and determine the most recent location indicator associated with the document. The device will search the loaded document to find the matching location indicator and will advance to the location in the content data that matches that location indicator. The device will then begin displaying or playing the document from the point of the location indicator. Once the alternative device 402 begins displaying or playing the document, it begins transmitting the transmitted data discussed above to all other alternative devices 403.

If the alternative device 402 receiving the transmitted data is not active at the time the data is received, in some embodiments, the alternative device may store the transmitted data until the user makes that receiving device active. At that point, the alternative device will process the transmitted data it has received as described above.

In some embodiments of the inventions, each of the devices that is active is continuously both sending and receiving the most recent transmitted data concerning each document that has been loaded, up to the limits of the storage capacity of the device that is devoted to such information. In such cases, each device compares the latest information it receives against the information stored internally for each document and determines which document is the most recently accessed by the user. If any of the information a device receives is more recent than the information in its internal memory, it resets its internal memory to reflect the most recent document. That updated information is then the minimum information that the device will transit to other devices.

As shown in FIG. 1, in some embodiments of the invention, a first version of a document 101 is generated which has 1) a unique identifier associated with the content of the document (“document identifier”) 205 and 2) location indicators 201 and 202 within the document that reflect progressive locations within the document.

One or more alternative versions 102 of the document are generated, each of which has 1) the same or analogous document identifier 206 and 2) the same or analogous location indicators 203 and 204 in the comparable locations within each alternative version of the document as those in the first version.

As shown in FIG. 3, if the alternative device 402 that receives the transmitted data is active, that alternative device will determine whether a) no documents are loaded, b) there are multiple documents loaded, or c) there is only one document currently loaded. If there are no documents loaded, the device will prompt the user to insert a document. If there are more than one documents loaded, the device will either review its memory to determine which is the document last viewed or listened to by the user, designate that document as the preferred document and load that document for listening or viewing; or, in the alternative, the device will inquire of the user through a visual or auditory interface which document the user wishes select. If only one document is loaded, the device will assume that the loaded document is the preferred document and will identify and select that document for comparison with the initial document. Once a document is both loaded and selected, the alternative device will determine whether the document identifier associated with that document corresponds to a document identifier that has been received and stored in its memory. If the device finds a match between the document identifier of the preferred document and the document identifier received, it will then determine the most recent location indicator received. The device will search the loaded document to find the matching location indicator and will advance to the location in the document data that corresponds to that indicator. The device will then begin displaying or playing the document from the point of the matching location indicator. The test performed using the document identifier is intended to avoid a mismatch between unrelated documents.

In some embodiments of the invention, the active device also transmits data reflecting the date and time that the location indicator was either stored in memory or transmitted (“date/time stamp”). This data can be used to determine the most recently accessed location indicator, as well as serve as a basis to select a preferred document.

In some embodiments of the invention, each type of device will have predetermined parameters identified reflecting the type of information it is capable of displaying or playing. For example, an audio-only device is capable of conveying spoken text and music or other audio information, but not visual or graphic data such as charts or images. A text-only display is only capable of displaying text, but not audio (sounds or music), high resolution graphics or video. A graphics-only device is capable of displaying text and graphics, but not audio. A multi-media device is capable of displaying and playing many if not all formats of the potential data. Data that is part of the overall document but that is not capable of being viewed or played on the device when that data is reached while the document is being accessed by the user is considered “skipped data” with regard to that device. Additional types of data identifiers can be implemented, for example three dimensional images, for types of data that are not presently capable of being readily accessed (such as portable holographic images) once there are practical devices capable of viewing or playing such data and such data is created for such display and retrieval.

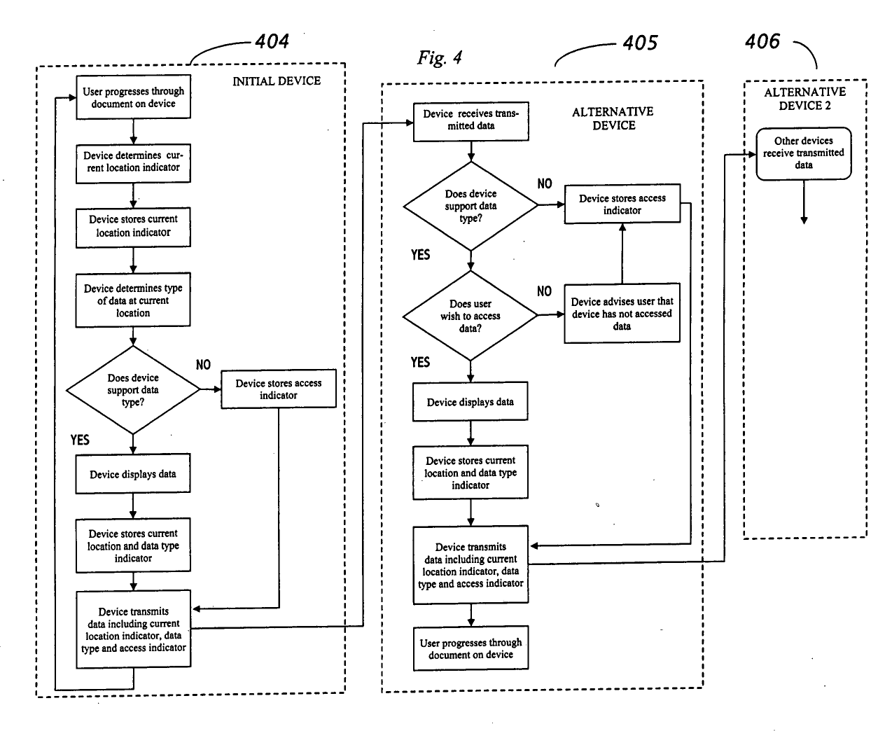

In some embodiments, each version of the document may include both the data which a particular device is capable of displaying or playing as well as data that a particular device cannot access. Each version of the document may also include standardized indicators for each specific type of data element (“data type markers”) it contains, so as to alert a given device as to whether that version of the document contains data the device may or may not be capable of displaying or playing. These data type markers are associated with each individual block of data of that type. As illustrated in FIG. 4, as the active device 404 accesses the document, it monitors the data to identify data type markers and, when it determines that it is incapable of playing or displaying a particular data block (“skipped data”), based upon a comparison between the data type marker encountered and its internal registry of data types it is capable of accessing, the device indicates to the user that there are skipped data which the device is incapable of playing or displaying. In some embodiments, the active device 404 creates an indicator reflecting that a particular data block was skipped, the location indicator of that data block and the data type indicator for that block (collectively a “skipped data marker”), stores information about any skipped data markers and transmits those skipped data markers to all alternative devices within range along with the other transmitted data.

When the user activates one of the other devices 405, the now active device reviews the transmitted data it has received from the prior active devices 404 to determine if there are skipped data markers. The active device 405 then determines if the skipped data are of a type that the device is capable of displaying or playing. If the device is capable, it informs the user that there is skipped data that is now available and asks the user if he or she wishes to view or play the skipped data, defer viewing or playing or erase the skipped data marker. For example, the user could be asked whether she or he wished to view a skipped chart now, later or never. The user would then have the opportunity to input one of those choices using an input mechanism on the device 405, for example a numbered key, a scrolling device that highlighted the choice, a touch screen input or a voice command. Once the user has either viewed or played the skipped data, or indicated that she or he never wishes to view or play that particular element of skipped data, the skipped data marker of that particular unit of skipped data is removed from the data that is to be transmitted. Otherwise, the skipped data is stored and eventually retransmitted to another device 406.

In one of the embodiments, the user would be assigned a user identifier that would either be a separate data point or would be used to supplement or modify the document identifier to make it user specific (collectively “user information”). The user information could be specifically input at the time of initial installation of, or access to, the document file. It also could be automatically input by the viewing or playing device if that device is set up to be user specific. It could also be input on a per-use basis. This user information would be transmitted from the initial device to the alternative device with the other transmitted data. When the receiving alternative device is made the active device, it evaluates the user information to ensure that it matches the user information contained in the version of the document that has been installed and loaded in that newly designated device. This check is made to ensure that, in the event that someone with a compatible device is within range of a user's device, and that other person's device transmits information concerning the same document that is received by the user's device, the user's device does not inadvertently process and act upon the transmitted data from the other person's device. In the alternative, a device can be preprogrammed with one or more users' individual identifiers entered into a user registry and will then reject any transmitted data that does not match the user information contained in its user registry or the devices may use transmission methodologies such as encryption that prevent or reject inadvertent reception.

In some embodiments of the invention, the initial device transmits a limited seeking signal in an attempt to contact a compatible device. When a compatible device receives the seeking signal, it transmits an acknowledging signal that is received by the initial device. Once the acknowledging signal is received, the initial device sends the full range of transmitted data.

In another embodiment, the seeking signal also includes user identification data. When the compatible device receives the seeking signal, it compares the user identification data to determine whether the identified user is listed in the compatible device's user registry. If the user is listed, the acknowledging signal is sent. If the user is not present in the registry, the compatible device will not send an acknowledging signal and the initial device will not send the transmitted data.

In some embodiments, the active device can be set to send the transmitted data only at preset intervals, or only when the user prompts the device to do so when the user believes he is within range of an alternative device or just before the user intends to begin use of the alternative device.

In some embodiments, one of the compatible devices is a printer that can receive transmitted data and content data, either directly from other compatible devices such as personal digital assistants or from a computer capable of receiving such data, in a format that allows the printer to generate a printed version of the document. The printer can be prompted to then generate a printed output ranging from a few pages to the entire document. The extent of, and options within, the printout can be determined by pre-set preferences or through a dialog between the user and the printer through the printer's use interface, the interface of a computer associated with the printer or the user interface of the sending device. The printout would also include the location indicators and other transmitted data. In the alternative, the printer could store and access media holding a version of the document and receive just the usual transmitted data. These aspects of the invention may be used most frequently when the user wishes to continue to access the document, but is not able, or does not wish, to utilize an electronic device. It is also most useful when the user does not want to transport the entire document or access device, or risk the loss or damage to the original pre-printed version of the document or device, such as when the user is taking the document to a recreational setting such as the beach, and generally has need for substantially less than the entire document.

In some of the embodiments, the transmitted data could be manually input into the alternative device. The user would view the transmitted data on a display contained on the current active device, hear it through the device's speaker or see it on the page of a printed version, and would then enter that data through the use of the hardware of the alternative device, such as entry of coded numbers through an actual or virtual keypad or through selections made in a graphic user interface shown on a display of the alternative device and generated by the operating system of the device or the viewer or player software. This alternative entry system would be used primarily when the last active version of the document in use is a paper version, either a pre-printed book type format or a printout of selected sections of the document, and the user is then about to make an alternative device the active device. The manual entry system could also be used when the automatic or manual broadcast of the transmitted data was not successful or was undesirable because of power conservation issues, such as a low battery, or restricted, such as in airplanes.

In some of the embodiments, the transmitted data could be input into the alternative device by the user through the use of voice recognition software. The user would view the transmitted data on the current active device (including a paper version) and would then recite coded numbers or other symbols representing the transmitted data into a microphone on the alternative device, or would make oral selections to prompts from a graphic user interface shown on a display of the alternative device or in response to audio prompts. These graphic or audio prompts would be generated by the operating system of the device or the viewer or player software. This alternative entry system also would be used primarily when the last active version of the document in use is a paper version, either a pre-printed book type format or a printout of selected sections of the document, and the user is then about to make an alternative device the active device. The manual entry system could also be used when the automatic or user initiated broadcast of the transmitted data was not successful or was undesirable because of power conservation issues, such as a low battery on the transmitting device, or when there were restrictions on electronic transmission, such as in an airplane.

In another embodiment, the paper versions of the document, whether existing as one of the originally distributed versions or a version generated by a printer controlled or directed by a user, would be pre-imprinted with the transmitted data on each page in an encoded format that is capable of being read using scanning or other receptor technology, such as a bar code reader or optical character recognition or other comparable proprietary or standardized systems, whether visually perceptible or not. When the user wishes to change from a printed version of the document to an electronic device, she or he would move the section of the last page viewed in front of or through a receptor unit on the next active device, such as an optical scanner, which would receive the transmitted data and process the information as in the other embodiments.

In another embodiment, the paper versions of the document would be pre-imprinted with the transmitted data on each page in an encoded format that is capable of being read using magnetic encoding technology, such as is used on credit cards or other comparable proprietary or standardized systems or any other functionally similar technology presently in use or developed in the future.

In another embodiment, the invention can be used to allow the synchronized viewing and playing of more than two versions of the document in two or more devices. The user loads the document into each device and progresses through the document on one of the devices (the “primary device”). As the user moves to the next segment of the document, the primary device sends the transmitted data to the alternative device which advances to the same segment of the document as is being viewed or played on the primary device. This embodiment could be used to simultaneously view textual data on one device, such as a personal digital assistant, while listening to an audio rendition of the text played on a CD player. This embodiment would have special value in foreign language training, allowing the student to view a written version of the language being learned and listen to an audio rendition of the same text at a pace that is most comfortable to the student. This embodiment would also allow the experience of encyclopedic material in which the textual data is presented on a small portable device, such as a tablet computer, and is coordinated with a graphic display on a large screen device, such as a nearby plasma display, of a video clip of content related to the textual page being viewed.

In another embodiment, the invention can be used to allow the synchronized viewing and playing of the same version of the document by two or more users. The users load the document into each device and one user controls the progresses through the document on the primary device. As the user of the primary device moves to the next segment of the document, the primary device sends the transmitted data to the alternative devices which advance to the same segment of the document as is being viewed or played on the primary device. This embodiment could be used by an instructor to guide individual students as the instructor progresses through the instructional material. This embodiment could also be used to facilitate the coordinated viewing of the same document by speakers of different languages who are each viewing a version of the document in their native language while progress through the document is being controlled by the user controlling the primary device.

In another embodiment of the invention, the transmitted data is transmitted by wire or optical cable from the initial device directly to an alternative device, or through various intermediary devices such as network servers, routers, telephonic modems or other transmission mechanisms.

In a preferred embodiment, a user would have multiple versions of a document including a paper version in book form, an electronic version installed on a personal digital assistant, an electronic version installed on a personal computer or home media player, an audio version in CD format for use on a specialized player in a car or on a specialized portable CD player, and a printer capable of generating an additional partial paper version, for travel or recreational use. The version in book form would have one or more location indicators on each page. The personal digital assistant would have a built in scanning receptor capable of reading the location indicators on the book format or on the version printed by the printer. The personal digital assistant would also have an internal memory capable of storing the document content as well as the transmitted data, and could also have removable media capable of storing content and transmitted data. The personal digital assistant would utilize software to display the document on its screen and would have a transmitter, such as an infrared, “WiFi” or “Bluetooth” transmitting system, to communicate transmitted data to the personal computer and the printer, as well as to other personal digital assistants. The personal computer would likewise have a scanning receptor, internal and removable memory, a display system and a transmitting system. The car player would include a receptor capable of receiving transmitted data from a personal digital assistant, a receptor capable of perceiving the transmitted data on a printed version such as the book format and a manual input device, such as a keypad for inputting transmitted data. It would also contain a processor capable of accessing media containing content and transmitted data and a playing system capable of providing audio output to the user. The portable CD player would have features and systems comparable to those of the car player. The printer would have a receptor capable of receiving the infrared, WiFi or Bluetooth transmissions from other devices such as a personal digital assistant, personal computer, portable CD player and/or manual input such as a keypad. The printer would also contain internal and removable memory capable of storing content and transmitted data. The printer would have sufficient internal processing capability to permit it to access and manipulate the data with or without connection to a personal or networked computer. The printer would be capable of printing a selection from or complete version of the document at the user's option. The printer would also have a transmitter, such as infrared, WiFi or Bluetooth, capable of communicating transmitted data to the personal digital assistant or personal computer. The printed version produced by the printer would contain transmitted data comparable to those in the book format. In this preferred embodiment, each version would contain both transmitted data and extended transmitted data and each devise would be capable of receiving, transmitting and processing all such data.

In an example of a preferred embodiment of the invention, a user would have a “book” in a paper, bound version. That user would also have a specialized PDA capable of storing, playing and/or displaying some or all of the content of the document in question. The user would also have a version of the book on the PDA that would include text and graphics. The user would read the bound paper version, and then use the PDA to scan a marker on the last page he had read and proceed to view the document on the PDA from that point forward.

In another embodiment, a user would have a PDA, as described above, as well as a specialized CD player in his car. When reached his vehicle, the PDA would transmit a signal via WiFi to the car CD player which would play a narration of the book from where he left off. When he left his vehicle, the car CD player would transmit a signal to his PDA indicating the last segment of the book heard, and as he walked to his office, he could continue to read text on his PDA.

In another embodiment, the user would also have a specialized portable CD player capable of storing the documents and receiving the location indicators. When the user was ready to switch from the visual display on his PDA, it would signal the CD player which would begin an audio narration, perhaps accompanied by background music or sound effects, from where he left off.

In another embodiment, the user would also have a program on his desktop computer which would receive the signal from his PDA or portable CD player and the computer would advance the document resident on a data disk or hard drive to the most recently experience section and proceed to display text, graphics, video, audio or a combination of these. The computer would also display any graphics or video that had been skipped while the user was progressing using the PDA.

In another embodiment, the user's PDA would also send a signal to his specialized printer that would print out the next chapter for him to read as he sat by the pool. When done, he could then once again scan the last page read with his PDA and continue reading on the PDA from where he left off.

While the present invention has been described in connection with the embodiments described herein, it will be understood that the present invention is capable of further modifications, and this application, including the appended claims, are intended to cover any variations, uses, or adaptations of the present invention following, in general, the principles of the present disclosures set forth herein and including such departures from the present disclosures that come with known or customary practices in the art to which the invention pertains. Also, the invention may suitably comprise, consist of or consist essentially of the elements or steps described herein. Further, the invention described herein suitably may comprise or be practiced in the absence of any element or step which is not specifically disclosed herein. Further, one or more steps described herein may be performed simultaneously with another step.

1. A method for synchronizing the accessing of data in a document on a plurality of devices, comprising the steps of:
a) within a first version of a document associated with a first device capable of making that document perceptible to a user, identifying a plurality of predetermined locations;
b) assigning a unique indicator to each of said locations within said first version of said document;
c) storing said first version of said document and said location indicators on media capable of being accessed by said first device;
d) determining the particular location indicator associated with the last location accessed by a user within said first version of said document on said first device;
e) transmitting from said first device said particular location indicator to at least one alternative device capable of accessing media containing an alternative version of said document and containing corresponding location indicators;
f) processing said transmitted particular location indicator on said alternative device so as to locate, in said alternative version of said document, the location indicator that corresponds to said particular location indicator transmitted by said first device;
g) in said alternative version of said document, accessing the data associated with said corresponding location indicator; and
h) making said data perceptible to a user.

2. The method described in claim 1 in which said transmitting process by said first device is continuously implemented.

3. The method described in claim 1 in which said transmitting process by said first device is automatically implemented.

4. The method described in claim 3 in which said transmitting process by said first device is implemented a plurality of times.

5. The method described in claim 1 in which said transmitting process is an audio signal and said alternative device utilizes a sound processing system.

6. The method described in claim 1 in which said transmitting process by said first device occurs upon the intervention of a user of the data.

7. The method described in claim 1 in which said transmitting process is the human voice and said alternative device utilizes a voice recognition process.

8. The method described in claim 1 in which said transmitting process is manual data entry.

9. The method described in claim 1 in which:
a) said transmitted data is stored on media capable of being accessed by said alternative device if, at the time of transmission, said alternative version of said document is not accessible on said alternative device; and
b) upon said alternative version of said document on said alternative device becoming accessible, said stored transmitted data is processed on said alternative device in accordance with the steps in claim 1.

10. A method for selecting a document and synchronizing the accessing of data in said document on a plurality of devices, comprising the steps of:
a) assigning a unique document identifier to a document;
b) within a first version of said document associated with a first device capable of making that document perceptible to a user, identifying a plurality of predetermined locations;
c) assigning a unique indicator to each of said locations within said first version of said document;
d) storing said first version of said document, said location indicators and said unique document identifier on media capable of being accessed by said first device;
e) determining the particular location indicator associated with the last location accessed by a user within said first version of said document on said first device;
f) transmitting from said first device said particular location indicator and said document identifier to at least one alternative device capable of accessing media containing an alternative version of said document and containing a corresponding document identifier and corresponding location indicators;
g) processing said transmitted document identifier on said alternative device so as to identify and select said alternative version of said document, which alternative version has a document identifier that corresponds to said transmitted document identifier;
h) if a document identifier that corresponds to said transmitted document identifier is present in said alternative version, processing said transmitted particular location indicator so as to locate, in said alternative version of said document, the location indicator that corresponds to said particular location indicator transmitted by said first device;
i) in said alternative version of said document, accessing the data associated with said corresponding location indicator; and
j) making said data perceptible to a user.

11. The method described in claim 10 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process; and
g) utilizing manual data entry

12. The method described in claim 10 in which said selection of said alternative version of said document is made automatically by said alternative device.

13. The method described in claim 10 in which said selection of said alternative version of said document occurs upon the intervention of a user of the data.

14. The method described in claim 10 in which:
a) said transmitted data is stored on media capable of being accessed by said alternative device if, at the time of transmission, at least one of the following conditions exist on said alternative device:
i) said corresponding document identifier is not accessible;
ii) said corresponding alternative version of said document is not accessible; and
b) upon said document identifier and said document becoming accessible on said alternative device alternative, said stored transmitted data is processed on said alternative device in accordance with the steps in claim 8.

15. A method for selecting a document associated with a particular user and synchronizing the accessing of data in said document on a plurality of devices, comprising the steps of:
a) assigning a unique document identifier to a document;
b) within a first version of said document associated with a first device capable of making that document perceptible to a user, identifying a plurality of predetermined locations;
c) assigning a unique indicator to each of said locations within said first version of said document;
d) assigning a unique identifier to a particular user;
e) storing said first version of said document, said unique document identifier, said user identifier and said location indicators on media capable of being accessed by said first device;
f) determining the particular location indicator associated with the last location accessed by a user within said first version of said document on said first device;
g) transmitting, from said first device, said location indicator, said document identifier and said user identifier to an alternative device capable of accessing media containing an alternative version of said document and containing a corresponding document identifier and corresponding location indicators;
h) processing said transmitted user indicator on said alternative device to determine whether there is a corresponding user indicator associated with said alternative device,
i) if said corresponding user identifier is present, processing said transmitted document identifier on said alternative device so as to identify and select said alternative version of said document, which alternative version has a document identifier that corresponds to said transmitted document identifier;
j) if a document identifier that corresponds to said transmitted document identifier is present in said alternative version, processing said transmitted particular location indicator so as to locate, in said alternative version of said document , the location indicator that corresponds to said particular location indicator transmitted by said first device;
k) and in said alternative version of said document, accessing the data associated with said corresponding location indicator; and
l) making said data perceptible to a user.

16. The method described in claim 15 in which the form of said transmission occurrence by said first device is selected from the group consisting of:
transmitting process by said first device is implemented in at least one of the following manners:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

17. The method described in claim 15 in which said selection of said alternative version of said document is made automatically by said alternative device.

18. The method described in claim 15 in which said selection of said alternative version of said document occurs upon the intervention of a user of the data.

19. The method described in claim 16 in which selection among a plurality of users is made automatically by said alternative device.

20. The method described in claim 15 in which selection among a plurality of users occurs upon the intervention of a user of the data.

21. The method described in claim 15 in which:
a) the transmitted data is stored on media capable of being accessed by said alternative device if, at the time of transmission, one or more of the following conditions exist on said alternative device:
i) said corresponding user identifier is not accessible;
ii) said corresponding document identifier is not accessible;
iii) said corresponding alternative version of said document is not accessible; and
b) upon said user identifier, said document identifier and said document becoming accessible on said alternative device, said stored transmitted data is processed on said alternative device in accordance with the steps in claim 16.

22. A method for synchronizing the accessing of data stored on a plurality of devices with different capabilities, comprising the steps of:
a) establishing a standardized catalog of types of data elements that may occur in a document;
b) assigning a standardized data type marker to each type of data element, one of which said markers may be a null or no identifier;
c) identifying the type of each data element within a first version of a document associated with a first device capable of
i) accessing one or more types of data elements within said first version of said document; and
ii) making one or more of those types of data elements perceptible to a user;
d) assigning one of said standardized data type markers to each data element within said first version of said document;
e) within said first version of said document, identifying a plurality of predetermined locations;
f) assigning a unique indicator to each of said locations within said first version of said document;
g) storing said first version of said document, said standardized data type markers and said location indicators on media capable of being accessed by said first device;
h) determining which of said standard types of data elements said first device is capable of accessing;
i) storing a record within said first device indicating which said types of data elements said first device is capable of accessing;
j) determining the location indicators associated with each location accessed by a user which said first device skipped because it was not capable of accessing such skipped data;
k) determining the particular location indicator associated with the last location accessed by a user within said first version of said document on said first device;
l) transmitting from said first device said particular location indicator and said skipped data markers to an alternative device capable of accessing media containing an alternative version of said document;
m) determining which of said standard types of data elements said alternative device is capable of accessing;
n) storing a record within said alternative device reflecting said types of data elements said alternative device is capable of accessing;
o) processing said skipped location indicators on said alternative device so as to locate, in said alternative version of said document alternative on said alternative device, said location indicators that corresponds to said skipped location indicators transmitted by said first device;
p) processing said standardized data type markers as they are encountered within said document on said alternative device;
q) if said alternative device is capable of accessing said type of data element associated with said skipped location indicators, accessing some portion of said skipped data in said alternative version of said document associated with said corresponding location indicators; and
r) making some portion of said skipped data perceptible to a user;
s) if said alternative device is not capable of accessing said type of data element, transmitting said skipped location indicators to any other device capable of accessing one or more types of data elements within said document.

23. The method described in claim 22 wherein at least one of said devices implements the steps of:
a) processing said particular transmitted location indicator on said alternative device so as to locate, in said alternative version of said document, said particular location indicator that corresponds to said particular location indicator transmitted by said first device;
b) processing said standardized data type markers as they are encountered within said document on said alternative device;
c) if said alternative device is capable of accessing said type of data element, accessing said data in said alternative version of said document associated with said corresponding location indicator; and
d) making said data perceptible to a user;
e) if said alternative device is not capable of accessing said type of data element, transmitting said particular location indicator and skipped location indicators to any other device capable of accessing one or more types of data elements within said document.

24. The method described in claim 22 wherein at least one of said devices provides an indication to a user when said device encounters a data element that said device is not capable of accessing.

25. The method described in claim 22 wherein at least one of said devices provides an indication to a user when device encounters a data element that said device is not capable of accessing and said indication describes the type of data element that has been encountered.

26. The method described in claim 22 wherein at least one of said devices provides an indication to the user when said device encounters a data element that said device is not capable of accessing, each such data element has a specific description of the material that cannot be accessed and said device provides said description to said user utilizing a data type that said device is capable of accessing.

27. The method described in claim 22 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

28. The method described in claim 22 wherein said alternative device offers a user the option of accessing said data elements that said alternative device is capable of accessing and the locations of which data elements have been reached but not accessed by said user while accessing corresponding versions of said document on another device.

29. A method for synchronizing the accessing of data in a document which exists in a plurality of versions, comprising the steps of:
a) within a first version of a document that is in printed form, identifying a plurality of predetermined locations;
b) assigning a unique indicator to each of said locations within said first version of said document;
c) recording said location indicators on the printed form of said first version;
d) determining the particular location indicator associated with the last location accessed by a user within said first version of said document;
e) transmitting from said first version said particular location indicator to at least a first device capable of accessing media containing an alternative version of said document and containing corresponding location indicators;
f) processing said transmitted particular location indicator on said first device so as to locate, in said alternative version of said document, the location indicator that corresponds to said particular location indicator transmitted by said first device;
g) in said alternative version of said document, accessing the data associated with said corresponding location indicator and
h) making said data perceptible to a user.

30. The method described in claim 29 in which said transmitting process is manual data entry.

31. The method described in claim 29 in which said transmitting process is implemented by exposing said particular location indicator to an optical receptor.

32. The method described in claim 29 in which said transmitting process is implemented by exposing said particular location indicator to an electromagnetic receptor.

33. The method described in claim 29 in which said transmitting process is the human voice and said alternative device utilizes a voice recognition process.

34. The method described in claim 29 in which:
a) said first device transmits a particular location indicator to at least one alternative device capable of accessing media containing a second alternative version of said document and containing corresponding location indicators;
b) said alternative device:
i) processes said transmitted particular location indicator so as to locate, in said second alternative version of said document, the location indicator that corresponds to said particular location indicator transmitted by said first device;
ii) accesses the data in said second alternative version of said document, associated with said corresponding location indicator; and
iii) makes said data perceptible to a user.

35. A method for synchronizing the accessing of data in a document on a plurality of devices, comprising the steps of:
a) within a first version of a document associated with a first device capable of making that document perceptible to a user, identifying a plurality of predetermined locations;
b) assigning a unique indicator to each of said locations within said first version of said document;
c) storing said first version of said document and said location indicators on media capable of being accessed by said first device;
d) determining the particular location indicator associated with the last location accessed by a user within said first version of said document on said first device;
e) transmitting from said first device said particular location indicator to at least one alternative device capable of
i) accessing media containing an alternative version of said document and containing corresponding location indicators; and
ii) printing some portion of said document;
f) processing said transmitted particular location indicator on said alternative device so as to locate, in said alternative version of said document, the location indicator that corresponds to said particular location indicator transmitted by said first device;
g) in said alternative version of said document, accessing the data associated with said corresponding location indicator; and
h) printing some portion of said document beginning with said data associated with said corresponding location indicator.

36. The method described in claim 35 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

37. A method for synchronizing the accessing of data in a document on a plurality of devices, comprising the steps of:
a) within a first version of a document associated with a first device capable of making that document perceptible to a user, identifying a plurality of predetermined locations;
b) assigning a unique indicator to each of said locations within said first version of said document;
c) storing said first version of said document and said location indicators on media capable of being accessed by said first device;
d) determining the particular location indicator associated with the last location accessed by a user within said first version of said document on said first device;
e) transmitting from said first device some portion of said document and said particular location indicator to at least one alternative device capable of
i) receiving some portion of said document and particular location indicator;
ii) storing said portion and particular location indicator;
iii) printing some portion of said document;
f) processing said transmitted particular location indicator on said alternative device so as to locate, in said transmitted portion of said document, the location indicator that corresponds to said particular location indicator transmitted by said first device;
g) in said transmitted portion of said document, accessing the data associated with said corresponding location indicator; and
h) printing some portion of said document beginning with said data associated with said corresponding location indicator.

38. The method described in claim 37 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

39. A system which synchronizes the accessing of data in a document stored on a plurality of devices, comprising
a) a first version of a document which contains:
i) a plurality of predetermined locations within said first version, and
ii) a plurality of unique indicators associated with said predetermined locations within said first version of said document;
b) a first device containing at least:
i) a means of accessing storage media on which said first version of a document and said location indicators are stored;
ii) a transducer capable of making said first version perceptible to a user;
iii) a mechanism for determining the particular location indicator associated with the last location accessed by a user within said first version of said document;
iv) a transmitter for transmitting said particular location indicator to an alternative device;
c) at least one alternative version of said document which contains a plurality of predetermined locations within said alternative version which correspond to predetermined locations within said first version;
d) a plurality of unique identifiers associated with said predetermined locations within said alternative version;
e) an alternative device containing:
i) a means of accessing storage media on which said alternative version of a document and said location indicators are stored;
ii) a transducer for making said alternative version perceptible to a user;
iii) a receiver for receiving from said first device, said transmitted particular location indicator;
iv) processor of said transmitted particular location indicator capable of locating, in said alternative version of said document, the location indicator that corresponds to said particular location indicator transmitted by said first device;
v) a mechanism for accessing the data in said alternative version of said document associated with said corresponding location indicator; and
vi) a transducer capable of making said data perceptible to a user.

40. The system described in claim 39 in which said transmitter in said first device operates continuously.

41. The system described in claim 39 in which said transmitter in said first device operates automatically.

42. The system described in claim 39 in which said transmitter in said first device operates a plurality of times.

43. The system described in claim 39 in which said transmitter in said first device utilizes a sound processing system.

44. The system described in claim 39 in which said transmitter in said first device operates upon the intervention of a user of the data.

45. The system described in claim 39 in which said transmitter in said first device utilizes a voice recognition process.

46. The system described in claim 39 in which said transmitter in said first device utilizes manual data entry.

47. The system described in claim 39 in which:
a) said transmitted data is stored on media capable of being accessed by said alternative device if, at the time of transmission, said alternative version of said document is not accessible on said alternative device; and
b) said alternative device is capable of processing said stored transmitted data as provided in claim 39 upon said document identifier and said document becoming accessible on said alternative device.

48. A system which synchronizes the accessing of data in a document stored on a plurality of devices, comprising
a) a first version of a document which contains:
i) a unique document identifier,
ii) a plurality of predetermined locations within said first version, and
iii) a plurality of unique indicators associated with said predetermined locations within said first version of said document;
b) a first device containing at least:
i) a means of accessing storage media on which said unique document identifier, said first version of a document and said location indicators are stored;
ii) a transducer capable of making said first version perceptible to a user;
iii) a mechanism for determining the particular location indicator associated with the last location accessed by a user within said first version of said document;
iv) a transmitter for transmitting said unique document identifier and said particular location indicator to an alternative device;
c) at least one alternative version of said document which contains;
i) a unique document identifier,
ii) a plurality of predetermined locations within said alternative version which correspond to predetermined locations within said first version;
iii) a plurality of unique identifiers associated with said predetermined locations within said alternative version;
d) an alternative device containing:
i) a means of accessing storage media on which said unique document identifier, said alternative version of a document and said location indicators are stored;
ii) a transducer for making said alternative version perceptible to a user;
iii) a receiver for receiving from said first device, said transmitted unique document identifier and said particular location indicator;
iv) a processor capable of:
1) recognizing said transmitted document identifier so as to identify and select said alternative version of said document, which alternative version has a document identifier that corresponds to said transmitted document identifier;
2) if a document identifier that corresponds to said transmitted document identifier is present in said alternative version, processing said transmitted particular location indicator so as to locate, in said alternative version of said document, the location indicator that corresponds to said particular location indicator transmitted by said first device;
3) processing said transmitted particular location indicator capable of locating, in said alternative version of said document, the location indicator that corresponds to said particular location indicator transmitted by said first device;
v) a mechanism for accessing the data in said alternative version of said document associated with said corresponding location indicator; and
vi) a transducer capable of making said data perceptible to a user.

49. The system described in claim 48 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

50. The system described in claim 48 in which said processor in said alternative device selects said alternative version of said document automatically.

51. The system described in claim 48 in which said processor in said alternative device selects said alternative version of said document upon the intervention of a user of the data.

52. The system described in claim 48 in which:
a) said transmitted data is stored on media capable of being accessed by said alternative device if, at the time of transmission, at least one of the following conditions exist on said alternative device:
i) said corresponding document identifier is not accessible;
ii) said corresponding alternative version of said document is not accessible; and
b) said alternative device is capable of processing said stored transmitted data as provided in claim 48 upon said document identifier and said document becoming accessible on said alternative device.

53. A system which synchronizes the accessing of data in a document stored on a plurality of devices, comprising
a) a first version of a document which contains:
i) a unique document identifier,
ii) an identifier unique to a particular user
iii) a plurality of predetermined locations within said first version, and
iv) a plurality of unique indicators associated with said predetermined locations within said first version of said document;
b) a first device containing at least:
i) a means of accessing storage media on which said unique document identifier, said user identifier, said first version of a document and said location indicators are stored;
ii) a transducer capable of making said first version perceptible to a user;
iii) a mechanism for determining the particular location indicator associated with the last location accessed by a user within said first version of said document;
iv) a transmitter for transmitting said unique document identifier, said user identifier and said particular location indicator to an alternative device;
c) at least one alternative version of said document which contains;
i) a unique document identifier,
ii) an identifier unique to a particular user,
iii) a plurality of predetermined locations within said alternative version which correspond to predetermined locations within said first version;
iv) a plurality of unique identifiers associated with said predetermined locations within said alternative version;
e) an alternative device containing:
i) a means of accessing storage media on which said unique document identifier, said user identifier, said alternative version of a document and said location indicators are stored;
ii) a transducer for making said alternative version perceptible to a user;
iii) a receiver for receiving from said first device, said transmitted unique document identifier, said user identifier and said particular location indicator;
iv) a processor capable of:
1) recognizing said transmitted user indicator so as to determine whether there is a corresponding user indicator associated with said alternative device,
2) if said corresponding user identifier is present, processing said transmitted document identifier so as to identify and select said alternative version of said document, which alternative version has a document identifier that corresponds to said transmitted document identifier;
3) if a document identifier that corresponds to said transmitted document identifier is present in said alternative version, processing said transmitted particular location indicator so as to locate, in said alternative version of said document, the location indicator that corresponds to said particular location indicator transmitted by said first device;
4) processing said transmitted particular location indicator capable of locating, in said alternative version of said document, the location indicator that corresponds to said particular location indicator transmitted by said first device;
v) a mechanism for accessing the data in said alternative version of said document associated with said corresponding location indicator; and
vi) a transducer capable of making said data perceptible to a user.

54. The system described in claim 53 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

55. The system described in claim 53 in which said processor in said alternative device selects said alternative version of said document automatically.

56. The system described in claim 53 in which said processor in said alternative device selects said alternative version of said document upon the intervention of a user of the data.

57. The system described in claim 53 in which said processor in said alternative device selects among a plurality of users automatically.

58. The system described in claim 53 in which said processor in said alternative device selects among a plurality of users upon the intervention of a user of the data.

59. The system described in claim 53 in which:
a) the transmitted data is stored on media capable of being accessed by said alternative device if, at the time of transmission, one or more of the following conditions exist on said alternative device:
i) said corresponding user identifier is not accessible;
ii) said corresponding document identifier is not accessible;
iii) said corresponding alternative version of said document is not accessible; and
b) said alternative device is capable of processing said stored transmitted data as provided in claim 53 upon said document identifier and said document becoming accessible on said alternative device.

60. A system which synchronizes the accessing of data in a document stored on a plurality of devices, comprising
a) a standardized catalog of types of data elements that may occur in a document;
b) a set of standardized data type markers each of which is associated with a said type of data element, one of which said markers may be a null or no identifier;
c) a first version of a document containing
i) at least one type of said data elements;
ii) at least one standardized data type marker associated with a said data element
iii) a plurality of predetermined locations;
iv) a plurality of unique indicators associated with said predetermined locations;
d) a first device capable of
i) accessing one or more said types of data elements within said first version of said document;
ii) making one or more of said types of data elements perceptible to a user;
iii) determining which of said standard types of data elements within said first version of a document said first device is capable of accessing;
iv) storing a record within said first device reflecting said types of data elements said first device is capable of accessing;
v) accessing storage media on which said first version of a document, said standardized data type markers and said location indicators are stored;
vi) determining the particular location indicator associated with the last location accessed by a user within said first version of said document;
vii) transmitting said particular location indicator to an alternative device;
viii) determining any location indicators associated with data elements within said first version of said document which said first device was not capable of accessing;
ix) transmitting said location indicators associated with data elements within said first version of said document which said first device was not capable of accessing to an alternative device;
e) an alternative device capable of:
i) containing an alternative version of said document; and
ii) accessing the data in said alternative version of said document associated with said corresponding location indicator;
f) in an alternative device capable of accessing media containing an alternative version of said document associated with said first version of said document, determining which of said standard types of data elements said alternative device is capable of accessing;
g) storing a record within said alternative device reflecting said types of data elements said alternative device is capable of accessing;
h) transmitting from said first device said particular location indicator to said alternative device;
i) processing said particular transmitted location indicator on said alternative device so as to locate, in said alternative version of said document on said alternative device, said particular location indicator that corresponds to said particular location indicator transmitted by said first device;
j) accessing the data in said alternative version of said document associated with said corresponding location indicator;
k) processing said standardized data type markers as they are encountered within said document on said alternative device;
l) determining if said alternative device is capable of accessing said type of data element:
m) accessing said data.

61. The system described in claim 60 in which said alternative device is capable of transmitting said particular location indicator to any other device capable of accessing one or more types of data elements within said document if said alternative device is not capable of accessing said type of data element.

62. The system described in claim 60 wherein at least one of said devices is capable of providing an indication to a user when said device encounters a data element that said device is not capable of accessing.

63. The system described in claim 60 wherein at least one of said devices is capable of providing an indication to a user when device encounters a data element that said device is not capable of accessing and describing the type of data element that has been encountered.

64. The system described in claim 60 wherein at least one of said devices is capable of providing an indication to the user when said device encounters a data element that said device is not capable of accessing, providing a specific description of the material that cannot be accessed and providing said description to said user utilizing a data type that said device is capable of accessing.

65. The system described in claim 60 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

66. The system described in claim 60 wherein said alternative device is capable of offering a user the option of accessing said data elements on said alternative version of said document which have been skipped while accessing a corresponding version of said document on another device.

67. A system which synchronizes the accessing of data in a document stored on a plurality of devices, comprising:
a) a first version of a document that is in printed form, which contains:
i) a plurality of predetermined locations within said first version, and
ii) a plurality of unique indicators associated with said predetermined locations on the printed form of said document;
b) a first device containing at least:
i) a means of accessing storage media on which an alternative version of said document and said location indicators are stored;
ii) a transducer capable of making said alternative version perceptible to a user;
iii) a mechanism for determining the particular location indicator associated with the last location accessed by a user within said first version of said document;
iv) a receiver capable of perceiving the location indicator that corresponds to the last location accessed by a user of the data;
v) processor capable of locating, in said alternative version of said document, the location indicator that corresponds to said last location indicator perceived by said first device;
vi) a mechanism for accessing the data in said alternative version of said document associated with said corresponding location indicator; and
vii) a transducer capable of making said data perceptible to a user.

68. The system described in claim 67 in which said receiver utilizes manual data entry.

69. The system described in claim 67 in which said receiver utilizes an optical receptor.

70. The system described in claim 67 in which said receiver utilizes an electromagnetic receptor.

71. The system described in claim 67 in which said receiver utilizes a voice recognition process.

72. The system described in claim 67 in which contains:
a) said first device which also contains a transmitter for transmitting said particular location indicator to an alternative device;
b) an alternative device containing:
i) a means of accessing storage media on which a second alternative version of said document and said location indicators are stored;
ii) a transducer for making said alternative version perceptible to a user;
iii) a receiver for receiving from said first device, said transmitted particular location indicator;
iv) processor of said transmitted particular location indicator capable of locating, in said alternative version of said document, the location indicator that corresponds to said particular location indicator transmitted by said first device;
v) a mechanism for accessing the data in said alternative version of said document associated with said corresponding location indicator; and
vi) a transducer capable of making said data perceptible to a user.

73. A system which synchronizes the accessing of data in a document on a plurality of devices, comprising:
a) a first version of a document which contains:
i) a plurality of predetermined locations within said first version, and
ii) a plurality of unique indicators associated with said predetermined locations within said first version of said document;
b) a first device containing at least:
i) a means of accessing storage media on which said first version of a document and said location indicators are stored;
ii) a transducer capable of making said first version perceptible to a user;
iii) a mechanism for determining the particular location indicator associated with the last location accessed by a user within said first version of said document;
iv) a transmitter for transmitting said particular location indicator to an alternative device;
c) at least one alternative version of said document which contains:
i) a plurality of predetermined locations within said alternative version which correspond to predetermined locations within said first version; and
ii) a plurality of unique identifiers associated with said predetermined locations within said alternative version;
d) at least one alternative device capable of
i) accessing media containing an alternative version of said document and containing corresponding location indicators; and
ii) printing some portion of said document
iii) processing said transmitted particular location indicator on said alternative device so as to locate, in said transmitted portion of said document, the location indicator that corresponds to said particular location indicator transmitted by said first device;
iv) in said transmitted portion of said document, accessing the data associated with said corresponding location indicator; and
v) printing some portion of said document beginning with said data associated with said corresponding location indicator.

74. The system described in claim 73 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

75. A system which synchronizes the accessing of data in a document on a plurality of devices, comprising:
a) a first version of a document which contains:
i) a plurality of predetermined locations within said first version, and
ii) a plurality of unique indicators associated with said predetermined locations within said first version of said document;
b) a first device containing at least:
i) a means of accessing storage media on which said first version of a document and said location indicators are stored;
ii) a transducer capable of making said first version perceptible to a user;
iii) a mechanism for determining the particular location indicator associated with the last location accessed by a user within said first version of said document;
iv) a transmitter for transmitting some portion of said document and said particular location indicator to an alternative device;
c) at least one alternative device capable of
i) receiving said transmitted portion of said document and said particular location indicator;
iii) processing said transmitted particular location indicator on said alternative device so as to locate, in said transmitted portion of said document, the location that corresponds to said particular location indicator transmitted by said first device;
iv) in said transmitted portion of said document, accessing the data associated with said corresponding location indicator; and
v) printing some portion of said document beginning with said data associated with said corresponding location indicator.

76. The system described in claim 75 in which the form of said transmission occurrence by said first device is selected from the group consisting of:
a) continuously;
b) automatically;
c) a plurality of times;
d) upon the intervention of a user of the data;
e) utilizing an audio signal and said alternative device utilizes a sound processing system;
f) utilizing the human voice and said alternative device utilizes a voice recognition process;
g) utilizing manual data entry

77. A device consisting of a:
a) a mechanism for accessing storage media on which
i) a first version of a document containing a plurality of predetermined locations is stored;
ii) a unique indicator assigned to each of said predetermined locations within said first version of said document are stored;
b) a means of determining the particular location indicator associated with the last location accessed by a user within said first version of said document;
c) a transmitter for transmitting said particular location indicator to an alternative device;
d) a transducer capable of making said first version perceptible to a user;
e) a mechanism for receiving from an alternative device, transmitted particular location indicators;
f) a means of processing said transmitted particular location indicators so as to locate, in a version of said document, the location indicator that corresponds to said particular location indicator transmitted by said alternative device;
g) a means for accessing the data in said alternative version of said document associated with said corresponding location indicator; and
h) a transducer capable of making said data perceptible to a user.

78. The device described in claim 77 in which said mechanism for receiving particular location indicators from an alternative device is an optical scanning mechanism.

79. The device described in claim 77 in which said mechanism for receiving particular location indicators from an alternative device is an electromagnetic receptor mechanism.

80. The device described in claim 77 in which said mechanism for receiving particular location indicators from an alternative device is a manual data entry mechanism.

81. The device described in claim 77 in which said means for receiving particular location indicators from an alternative device is a voice recognition system.

82. A device consisting of a:
a) a mechanism for accessing storage media on which
i) a first version of a document containing a plurality of predetermined locations is stored;
ii) a unique indicator assigned to each of said predetermined locations within said first version of said document are stored;
b) a mechanism for receiving from an alternative device, a transmitted particular location indicator that corresponds to a location in an alternative version of said document;
c) a means of processing said transmitted particular location indicators so as to locate, in said first version of said document, the location indicator that corresponds to said particular location indicator transmitted by said alternative device;
d) a means for accessing the data in said first version of said document associated with said corresponding location indicator; and
e) a means of printing some portion of said document beginning with said data associated with said corresponding location indicator.

83. The device described in claim 82 in which said mechanism for receiving said particular location indicators from an alternative device is an optical scanning mechanism.

84. The device described in claim 82 in which said mechanism for receiving said particular location indicators from an alternative device is an electromagnetic receptor mechanism.

85. The device described in claim 82 in which said mechanism for receiving said particular location indicators from an alternative device is a manual data entry mechanism.

86. The device described in claim 82 in which said mechanism for receiving said particular location indicators from an alternative device is a voice recognition system.

87. A device consisting of a:
a) a mechanism capable of receiving from an alternative device, a portion of a first version of a document and a particular location indicator that corresponds to a location in said first version of said document;
b) a means of processing said transmitted particular location indicators so as to locate, in said transmitted portion of said first version of said document, the location that corresponds to said particular location indicator transmitted by said alternative device;
c) a means for accessing the data in said first version of said document associated with said corresponding location indicator; and
d) a means of printing some portion of said document beginning with said data associated with said corresponding location indicator.

88. The device described in claim 87 in which said mechanism for receiving said portion of said first version of said document and said particular location indicators from an alternative device is an optical scanning mechanism.

89. The device described in claim 82 in which said mechanism for receiving said portion of said first version of said document and said particular location indicators from an alternative device is an electromagnetic receptor mechanism.

90. The device described in claim 82 in which said mechanism for receiving said portion of said first version of said document and said particular location indicators from an alternative device is a manual data entry mechanism.

91. The device described in claim 82 in which said mechanism for receiving said portion of said first version of said document and said particular location indicators from an alternative device is a voice recognition system.
